(19) United States
(12) Patent Application Publication
(10) Pub. No.: US 2012/0055915 A1
(43) Pub. Date: Mar. 8, 2012

(54) HEAT TREATMENT APPARATUS

(75) Inventors: Ken'etsu Yokogawa, Tsurugashima (JP); Masatoshi Miyake, Kamakura (JP)

(73) Assignee: HITACHI HIGH-TECHNOLOGIES CORPORATION

(21) Appl. No.: 12/955,020

(22) Filed: Nov. 29, 2010

(30) Foreign Application Priority Data
Sep. 8, 2010 (JP) 2010-200845

(51) Int. Cl. H05B 7/18; H05B 1/02

(52) U.S. Cl. 219/383; 219/491

(57) ABSTRACT

Provided is a heat treatment apparatus that even when annealing SiC at high temperature, can exhibit a low heat capacity and perform uniform heating. The heat treatment apparatus includes a pair of parallel plate electrodes, high-frequency power supply that applies a high-frequency voltage to the pair of parallel plate electrodes so as to discharge between the pair of parallel plate electrodes, a temperature measurement instrument that measures the temperature of a sample to be heated which is disposed in the pair of parallel plate electrodes, a gas introduction unit that introduces a gas to the pair of parallel plate electrodes, reflection mirrors that surround the pair of parallel plate electrodes, and a control unit that controls the output of the high-frequency power supply. Heating of a gas due to discharge between the pair of parallel plate electrodes is used to thermally treat the sample to be heated.

### CLAIM OF PRIORITY

The present application claims priority from Japanese Patent Application JP 2010-200845 filed on Sep. 8, 2010, the content of which is hereby incorporated by reference into this application.

### BACKGROUND OF THE INVENTION

1. Field of the Invention

The present invention relates to a semiconductor fabrication apparatus that fabricates semiconductor devices. More particularly, the present invention is concerned with a heat treatment apparatus that performs activation annealing or defect repair annealing, which is preceded by doping of an impurity and intended to control the conductivity of a semiconductor substrate, and oxidation or the like of the surface of the semiconductor substrate.

2. Description of the Related Art

In recent years, an expectation has been put on introduction of a novel material having a wide bandgap, such as, silicon carbide (SiC) (or gallium nitride (GaN)) as a substrate material of a power semiconductor device. Since SiC has a wider bandgap than silicon (Si) that is an existing material, if SiC is adopted for a switching device or a Schottky barrier diode that is used to construct an inverter or the like, a dielectric strength can be improved and a leakage current can be minimized accordingly. Eventually, power consumption can be reduced.

A process of fabricating various types of power devices using SiC as a substrate material is almost identical to a process in which Si is used as the substrate material, though the size or the like of the substrate is different between the SiC substrate and Si substrate. As a sole largely different process, a heat treatment process is cited. What is referred to as the heat treatment process is represented by activation annealing that is preceded by ion implantation of an impurity and intended to control the conductivity of the substrate. In the case of a Si device, the activation annealing is performed at the temperature ranging from 800° C. to 1200° C. However, in the case of SiC, the temperature ranging from 1800° C. to 2000° C. is necessary in terms of the material properties.

As an annealing apparatus, a resistive heating furnace described, for example, in Japanese Patent Application Laid-Open Publication No. 2009-32774 is known. Aside from the resistive heating furnace type, an annealing apparatus of an induction heating type described in, for example, Japanese Patent Application Laid-Open Publication No. 2010-34481 is known.

### SUMMARY OF THE INVENTION

When the resistive heating furnace described in Japanese Patent Application Laid-Open Publication No. 2009-32774 is used to perform heating at 1800° C. or more, problems described below become severe.

A first problem lies in heat efficiency. Heat dissipation from a furnace body is dominated by radiation, and a radiant quantity increases in proportion to a biquadrate of temperature. Therefore, if a region to be heated is wide, energy efficiency necessary to heating markedly degrades. For a resistive heating furnace, a double-tube structure is usually adopted in order to avoid contamination caused by a heater. The region to be heated therefore gets wider. In addition, since a sample to be heated recedes from a heat source (heater) due to the presence of a double tube, it is necessary to set the heater to the temperature higher than the temperature of the sample to be heated. This also becomes a factor of largely degrading the efficiency. For similar reasons, the heat capacity of the region to be heated gets very large, and it takes much time to raise or lower the temperature. Accordingly, the time it takes to eject the sample to be heated after the sample to be heated is inputted gets longer. This becomes a factor of decreasing a throughput, or a factor of intensifying the surface roughness of the sample to be heated, which will be described later, because the time during which the sample to be heated stays in a high-temperature environment gets longer.

A second problem is concerned with wastage of a furnace material. Materials capable of coping with 1800° C. and being adopted as the furnace material are limited. A high-purity material of a high melting point is necessary. The furnace material capable of being used for SiC is graphite or SiC itself. In general, a sintered SiC compact or a material having the surface thereof coated with SiC according to a chemical vapor phase deposition method is adopted. These materials are usually expensive. If a furnace body is large, a considerable cost is necessary to replacement. The higher the temperature is, the shorter the service life of the furnace body is. The cost of replacement gets higher than that in the normal Si process.

In contrast, the induction heating method described in Japanese Patent Application Laid-Open Publication No. 2010-34481 is a method of heating an object of heating by feeding a high-frequency induction current to the object of heating or a placement member on which the object of heating is placed. Compared with the aforesaid resistive heating furnace method, the induction heating method enjoys high heat efficiency. However, in the case of induction heating, if the electric resistivity of the object of heating is low, a large induction current is necessary to heating. The absolute value of the heat efficiency of an entire heating system is not always high (a heat loss occurring in an induction coil or the like is large). The induction heating method is therefore confronted with a problem on heat efficiency.

Heating uniformity is determined with the induction current that flows into the object of heating or the placement member on which the object of heating is placed. The heating uniformity may not be sufficiently attained for a planar disk like the one employed in device fabrication. If the heating uniformity is poor, there is a fear that the object of heating may be broken due to a thermal stress during rapid heating. This becomes a factor of decreasing a throughput because of the necessity of lowering a speed of a temperature rise to such an extent that a stress is not generated. Further, similarly to the resistive heating furnace method, steps of producing and removing a cap film that prevents evaporation of Si from a SiC surface at the time of extremely high temperature are additionally necessary.

An object of the present invention is to provide a heat treatment apparatus that even when annealing SiC at high temperature, can exhibit a low heat capacity and perform uniform heating.

As an embodiment for accomplishing the above object, there is provided a heat treatment apparatus including a pair of parallel plate electrodes, a high-frequency power supply that applies a high-frequency voltage to the pair of parallel plate electrodes so as to discharge between the pair of parallel plate electrodes, a temperature measurement instrument that measures the temperature of a sample to be heated which is disposed in the pair of parallel plate electrodes, a gas introduction unit that introduces a gas into the pair of parallel plate electrodes, reflection mirrors that surround the pair of parallel plate electrodes, and a control unit that controls the output of the high-frequency power supply. The control unit references the temperature measured by the temperature measurement instrument, and controls the output of the high-frequency power supply so as to control the heat treatment temperature for the sample to be heated.

Further provided is a heat treatment apparatus including a high-frequency power supply, a lower electrode on which a sample to be heated is placed, an upper electrode to which the high-frequency power supply is connected and which is located at a position opposite to the position of the lower electrode, a gas introduction unit that introduces a gas, which is used to produce plasma due to discharge, into the space between the upper electrode and lower electrode, and upper and lower reflection mirrors that cover the upper and lower electrodes via a space.

Owing to adoption of glow discharge, there is provided a heat treatment apparatus that even when annealing SiC at high temperature, can exhibit a low heat capacity and achieve uniform heating. In particular, inclusion of reflection mirrors suppresses a radiation loss and permits high-temperature heat treatment.

### BRIEF DESCRIPTION OF THE DRAWINGS

FIG. 1A is a diagram showing a basic construction of a heat treatment apparatus in accordance with a first embodiment of the present invention employing plasma;

FIG. 1B is a diagram showing the relationship between a thermal electron current and electrode temperature;

FIG. 1C is a diagram for use in explaining the fact that a radiation loss is minimized by reflection mirrors;

FIG. 2A is a sectional view of a discharge formation unit included in a heat treatment apparatus in accordance with a second embodiment of the present invention employing plasma;

FIG. 2B is a sectional view of another discharge formation unit included in the heat treatment apparatus in accordance with the second embodiment of the present invention employing plasma;

FIG. 3 is a diagram showing a basic construction of a heat treatment apparatus in accordance with a third embodiment of the present invention employing plasma (a state in which treatment is under way);

FIG. 4 is a diagram showing the basic construction of the heat treatment apparatus in accordance with the third embodiment of the present invention employing plasma (a state in which treatment has been completed); and

FIG. 5 is a diagram showing an example of a sequence of basic actions of the heat treatment apparatus shown in FIG. 1A.

### DESCRIPTION OF THE PREFERRED EMBODIMENTS

In a mode for implementing the present invention, a sample to be heated is disposed in a pair of parallel plate electrodes in which a gap ranging from 0.1 mm or more to 2 mm or less is created, and the gap is filled with a gas that contains as a main raw material a rare gas (helium (He), argon (Ar), krypton (Kr), xenon (Xe), or the like) whose pressure is close to atmospheric pressure. A high-frequency voltage is applied to the pair of parallel plate electrodes in order to produce plasma. The gas is heated with the plasma, whereby the sample to be heated is thermally treated.

Owing to heating of a gas with plasma, a heat treatment apparatus can be provided for fabrication of semiconductor devices that needs extremely high temperature of about 2000° C. Eventually, heating efficiency can be improved, a throughput can be improved due to shortening of a heating treatment time, a cost of operation such as a cost incurred by wastage of a furnace material can be reduced, and the surface roughness of a sample to be heated caused by extremely high temperature can be suppressed.

Embodiments will be described below.

### First Embodiment

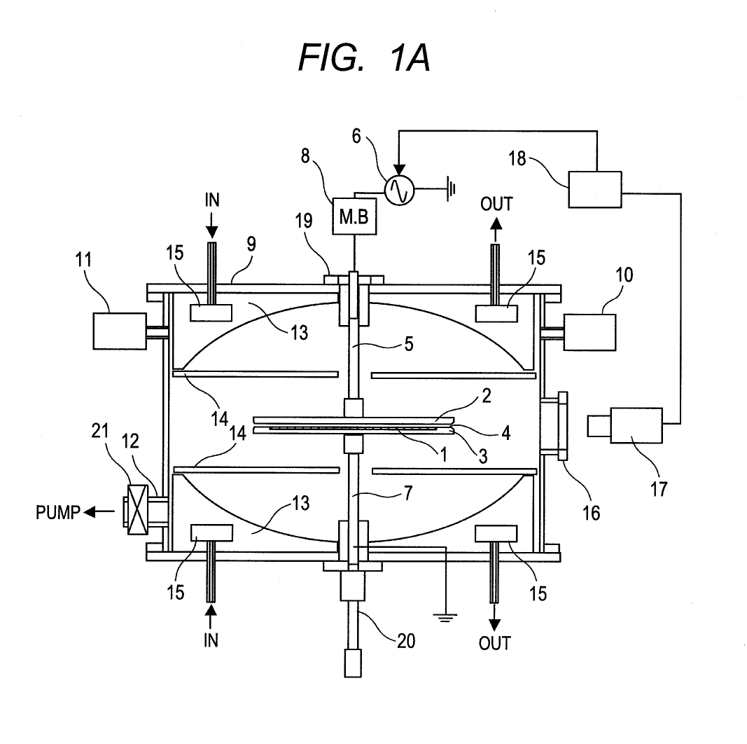

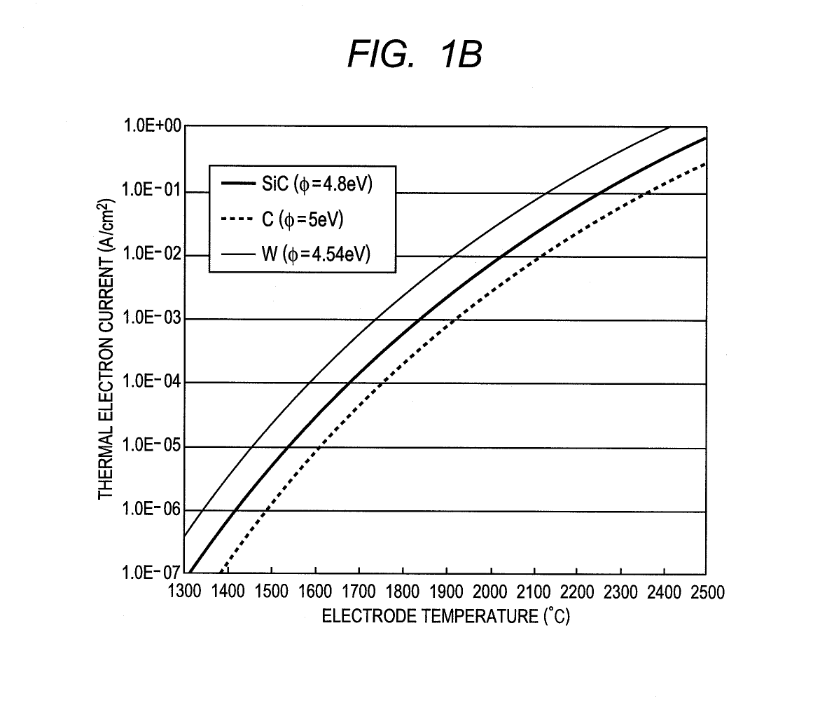

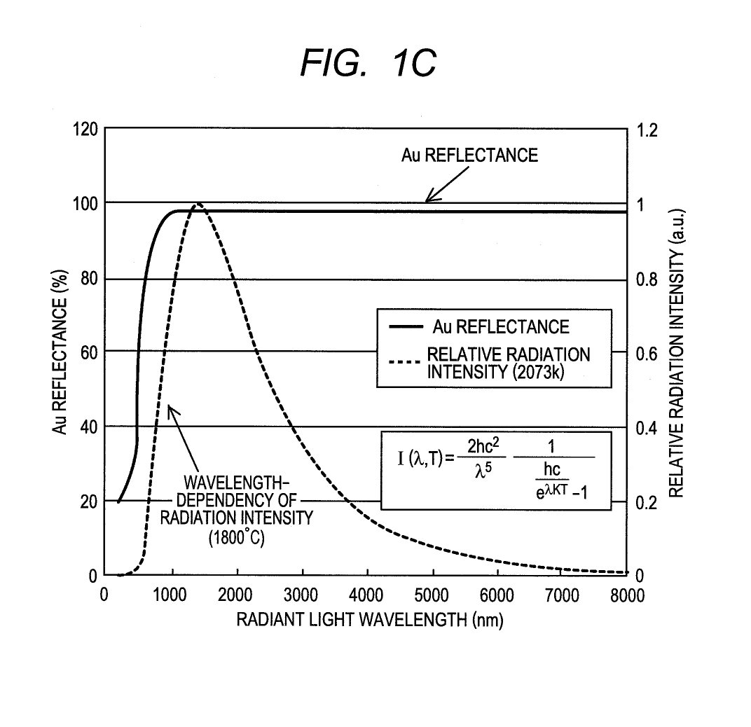

FIG. 1A shows a basic construction of a heat treatment apparatus in accordance with the present embodiment employing plasma. To begin with, the construction of the heat treatment apparatus will be described below. A sample to be heated 1 is placed in a pair of parallel plate electrodes including an upper electrode 2 and a lower electrode 3. In the present embodiment, single-crystal silicon carbide (SiC) of 4 inch (Ø 100 mm)
in diameter was adopted as the sample to be heated 1. The diameter of the upper electrode 2 and lower electrode 3 was 120 mm, and the thickness thereof was 5 mm. As each of the upper electrode 2 and lower electrode 3, a graphite substrate having silicon carbide accumulated on the surface thereof according to a chemical vapor phase deposition method was adopted.

The sample to be heated 1 was placed on the lower electrode 3, and the gap 4 between the upper electrode 2 and lower electrode 3 was 0.8 mm. The sample to be heated 1 has a thickness ranging from 0.5 mm to 0.8 mm. A dent in which the sample to be heated 1 is locked is formed in the lower electrode 3 on which the sample to be heated 1 is placed, though it is not shown in the drawing. The circumferential corners of the upper electrode 2 and lower electrode 3 that are opposed to each other are tapered or rounded. This is intended to suppress localization of plasma due to concentration of an electric field at the corner of the electrode.

A high-frequency power is fed from a high-frequency power supply 6 to the upper electrode 2 over a feeder line 5. In the present embodiment, 13.56 MHz was adopted as the frequency of the high-frequency power supply 6. The lower electrode 3 is grounded over a feeder line 7. The feeder lines 5 and 7 are made of graphite that is a material made into the upper electrode 2 and lower electrode 3 alike. A matching circuit 8 (M.B in the drawing stands for matching box) is interposed between the high-frequency power supply 6 and upper electrode 2. A structure for efficiently feeding the high-frequency power from the high-frequency power supply 6 to the plasma produced between the upper electrode 2 and lower electrode 3 is thus realized.

To a container 9 in which the upper electrode 2 and lower electrode 3 are disposed, a He gas can be introduced at a pressure, which ranges from 0.1 atm. to 10 atm., by means of a gas introduction unit 10. The pressure of the gas to be introduced is monitored by a pressure detection unit 11. In addition, the gas can be exhausted from the container 9 by a vacuum pump connected to an exhaust vent 12. The container 9 is deaerated to be vacuum at a step preceding introduction of the He gas. After the container 9 is deaerated, the gas is introduced by the gas introduction unit 10 until the gas has a predetermined pressure. Thus, the atmosphere in the container 9 can be brought to an atmosphere of a desired pure gas (He in the present embodiment). In addition, the predetermined pressure can be retained by combining introduction of a certain amount of gas, which is performed by the gas introduction unit 10, with exhaustion thereof. The gas introduction unit can be controlled by the control unit 18.

The upper electrode 2 and lower electrode 3 in the container 9 are surrounded by reflection mirrors 13 each formed with a paraboloid of revolution. A protective quartz plate 14 is interposed between the upper electrode 2 and the reflection mirror 13 and between the lower electrode 3 and the reflection mirror 13. The reflection mirror 13 formed with the paraboloid of revolution is constructed by optically polishing the paraboloid of a metallic substrate, and plating or vapor-depositing gold on the polished surface. In addition, a coolant channel 15 is formed in the metallic substrate of the reflection mirror 13. Cooling water is poured into the channel so that the temperature of the metallic substrate can be held constant.

The upper electrode 2 or lower electrode 3 can be measured through a window 16 using a radiation thermometer 17. The radiation thermometer 17 is used to measure the temperature of the sample to be heated 1. The result of the measurement by the radiation thermometer 17 is processed by the control unit 18, and the output of the high-frequency power supply 6 is automatically controlled so that the temperature of the sample to be heated 1 becomes desired temperature. The temperature of the sample to be heated 1 can be considered to be identical to the temperature of the upper electrode 2 or lower electrode 3, or especially, to the temperature of the lower electrode 3.

Next, the basic actions of the heat treatment apparatus having the construction shown in FIG. 1A will be described below. After the sample to be heated 1 is placed on the lower electrode 3, the gap 4 between the upper electrode 2 and lower electrode 3 is set to 0.8 mm by means of an up-and-down mechanism 20 (the same applies to the distance between the upper electrode 2 and the sample to be heated 1). Thereafter, the container 9 is deaerated by the vacuum pump, which is connected through the exhaust vent 12, until the pressure therein becomes 1 Pa or less, and is then brought to a vacuum state by means of a vacuum valve 21. A He gas is introduced from the gas introduction unit 10 to the container 9 until the gas pressure becomes a desired one. In the present embodiment, the He pressure in the container 9 was set to 1 atm. (1013 hectopascal).

In a stage in which the pressure in the container becomes steady, a high-frequency power is applied from the high-frequency power supply to the upper electrode 2 via the matching circuit 8 through a power introduction terminal 19 over the feeder line 5. He plasma is produced in a glow discharge region in the gap 4. In the present embodiment, the high-frequency power to be fed to the upper electrode 2 was set to 2000 W. The high-frequency energy is absorbed by electrons contained in the plasma, and atoms or molecules of the raw gas are heated due to collision of the electrons. In the plasma produced under a pressure close to atmospheric pressure, the frequency of collision of the electrons with the gas atoms and molecules is so high that a thermal equilibrium state is established, that is, the temperature of the electrons and the temperature of the atoms and molecules become nearly equal to each other. The temperature of the raw gas can be readily raised to the temperature ranging from 1000° C. to 2600° C.

The sample to be heated 1 is heated due to contact of the heated high-temperature gas and radiation thereof. The temperature of the sample to be heated 1 can be raised from the temperature, which is 70% or more of the gas temperature, to the temperature nearly equal to the gas temperature. The surface of the upper electrode 2 opposed to the sample to be heated 1 is also heated and comes to have the temperature nearly equal to the temperature of the sample to be heated. As far as a solid whose temperature is 1000° C. or more is concerned, a percentage at which thermal energy is emitted due to radiation is high (a magnitude of radiation increases in proportion to the fourth power of temperature). Therefore, radiation from the upper electrode 2 contributes to heating of the sample to be heated. Owing to the foregoing principles, the sample to be heated 1 can be heated from several hundreds of degrees to the temperature necessary to activate SiC (ranging from about 1800° C. to about 2000° C.).

Since plasma is produced in a glow discharge region, the plasma can be formed to uniformly spread between the upper electrode 2 and lower electrode 3. The planar plasma is used as a heat source to heat the sample to be heated 1. This makes it possible to uniformly heat the planar sample to be heated 1. During the heating, a high-temperature portion is limited to the upper electrode 2 and the lower electrode 3 including the sample to be heated 1. The heat capacity of a region to be heated can be extremely reduced, and the temperature of the sample to be heated can be raised or lowered at a high speed. In addition, since the sample to be heated can be heated uniformly on a planar basis, even if the temperature thereof is raised rapidly, a risk that a break or the like may stem from non-uniformity in the temperature of the sample to be heated 1 is low. Therefore, the temperature of the sample to be heated can be raised or lowered at a high speed, and the time it takes to complete a series of heating treatment steps can be shortened. Owing to this advantage, a throughput of heating treatment can be improved. In addition, unnecessarily long stay of the sample to be heated 1 in a high-temperature atmosphere can be suppressed. Roughness on the SiC surface stemming from evaporation of Si from SiC heated at high temperature can be minimized.

Since the temperature of the sample to be heated 1 is nearly identical to the temperature of the lower electrode 3, when the temperature of the lower electrode 3 is measured with the radiation thermometer 17, the temperature of the sample to be heated 1 can be measured. Since the control unit 18 controls the output of the high-frequency power supply 6 by referencing the result of the measurement of the temperature of the sample to be heated 1 performed by the radiation thermometer 17, the temperature of the sample to be heated 1 can be highly precisely controlled (1800° C.±10° C. or less).

In the present embodiment, according to the foregoing operation, the sample to be heated 1 was heated up to 1800° C., which was necessary to activation of a SiC device succeeding ion implantation, and annealed for 1 min. As a result, uniformity represented by an in-plane resistivity of the sample to be heated that is ±3% or less was attained. During the heating, when glow discharge is sustained, heating can be achieved uniformly on a planar basis. When a transition is made from the glow discharge to arc discharge, formation of plasma is localized. Uniform heating becomes hard to do. At the same time, the temperature of the sample to be heated becomes several thousands of degrees or more, that is, becomes unnecessarily high, and it becomes hard to control the temperature. Therefore, in the present embodiment, the upper limit of a range of temperatures up to which the sample to be heated is heated is preferably about 2000° C. at which glow discharge can be sustained. When the temperature is equal to or larger than 2000° C., a quantity of thermal electrons emitted from the electrode surface increases to the gap 4. Eventually, a risk that a transition may be made to arc discharge gets higher.

A transition to arc discharge is, as mentioned previously, largely related to emission of thermal electrons deriving from a temperature rise at an electrode. Glow discharge is sustained with emission of secondary electrons from the electrode. However, when the quantity of thermal electrons exceeds that of secondary electrons, discharge becomes unstable and makes a transition to the arc discharge. The quantity of thermal electrons emitted from the electrode is expressed by the Richardson-Dushman's formula (1) presented below, and determined with the temperature of the electrode material and a work function.

$$\begin{matrix}[ Formula 1 ] & \\ J ( A \text{/} {m}^{2} ) = \frac{4 π {mk}^{2} e}{{h}^{3}} \times {T}^{2} exp ( \frac{- W}{kT} ) & ( 1 )\end{matrix}$$

In the formula (1), J denotes a quantity of emitted thermal electrons per unit area, m denotes a mass of electrons, k denotes a Boltzmann coefficient, e denotes an elementary electric charge, h denotes a Planck constant, T denotes an absolute temperature of an electrode, and W denotes a work function of an electrode material. FIG. 1B shows the relationships between the quantities of emitted thermal electrons of tungsten (W), silicon carbide (SiC), and carbon (C) deduced from the formula (1) and the temperature. Tungsten is cited for reference because it is widely adopted as a thermal electron source. In the case of tungsten, the quantity of thermal electrons exceeds the quantity of secondary electrons, and the temperature at which a transition is made from glow discharge to arc discharge ranges from about 1800° C. to about 2100° C. An electrode material employed in the present embodiment is carbon or SiC (which may be coated over carbon). Both of SiC and carbon are larger than tungsten in terms of the work function. Therefore, as long as the temperature remains unchanged, the quantity of thermal electrons is smaller than that from tungsten. Since the transition to arc discharge is determined with the quantity of thermal electrons, when carbon or SiC is adopted as the electrode material, the temperature at which the transition to arc discharge is made is higher than that observed when tungsten is adopted.

Assuming that the temperature determined with a quantity of thermal electrons emitted from carbon, which is identical to the quantity of thermal electrons emitted from tungsten at the time of a transition to arc discharge is the temperature at which a transition is made to arc discharge, the temperature ranges from about 2030° C. to about 2300° C. Therefore, when a carbon electrode is employed, glow discharge can be sustained at about 2000° C. or less, and heating based on glow discharge can be achieved. Likewise, for an electrode made of SiC or formed by coating a carbon substrate with SiC according to a chemical vapor deposition (CVD) method or the like, the temperature ranges from 1900° C. to 2200° C. Heating based on glow discharge can be achieved at about 1900° C. or so. In reality, emission of thermal electrons will not overwhelm sustention of discharge at a lower limit of temperatures at which glow discharge is sustained. Therefore, glow discharge can be sustained at about 2000° C. at most irrespective of whether it is caused by a carbon electrode or SiC electrode.

In order to highly efficiently raise the temperature of the upper electrode 2 and lower electrode 3 (including the sample to be heated 1), it is necessary to suppress heat transfer over the feeder lines 5 and 7, heat transfer through an He gas atmosphere, and radiation from a high-temperature region (in the infrared spectrum and visible light region). In particular, in an extremely high-temperature state of 1800° C., heat dissipation due to radiation is quite dominant. Minimization of a radiation loss is essential to improvement of heating efficiency. In the present embodiment, the minimization of the radiation loss is implemented by the reflection mirrors 13. The reflection mirror 13 is formed by coating a paraboloid of revolution, which is optically polished, with gold that upgrades the reflectance of infrared light. The reflection mirrors 13 are disposed to cover the upper electrode 2 and lower electrode 3 with the paraboloids of revolution with which the reflection mirrors are formed. Thus, radiant light can be reflected to the perimeters of the upper electrode 2 and lower electrode 3 that are regions to be heated. This permits the minimization of the radiation loss.

FIG. 10 shows a radiant spectrum emitted from an electrode having 1800° C., and the reflectance of gold (Au) having been polished to have a mirror surface. In the case of gold, the reflectance thereof decreases with respect to visible light (600 nm or less), but the high reflectance (ranging from 95% to 98%) is retained with respect to the nearly entire radiant spectrum available at 1800° C. As seen from the drawing, the reflectance of about 97% on average is ensured. In reality, since various losses are produced, the reflectance is about 90% on average. When the mirror surface having the reflectance is used to form the reflection mirrors 13 shown in FIG. 1A, a loss caused by radiation can be minimized.

The mirror surfaces of the reflection mirrors 13 exhibit the reflectance of about 90% with respect to radiant light. However, since the reflection mirrors 13 provide multipath reflection, absorbed radiant energy causes the temperature of the reflection mirrors 13 to rise. A heat loss transferred from the upper electrode 2 and lower electrode 3 through a He gas atmosphere leads to a rise in the temperature of the reflection mirrors 13. When the temperature of the reflection mirrors 13 becomes several hundreds of degrees or more, there arises a possibility that the sample to be heated 1 may be contaminated due to a decrease in the reflectance, which derives from deterioration of the mirror surfaces, and emission of an impurity. In the present embodiment, the coolant channel 15 is formed in the metallic substrate of each of the reflection mirrors 13 so that cooling water can flow through the channel. Thus, the temperature rise at the reflection mirrors 13 themselves is suppressed. The protective quartz plates 14 are interposed between the reflection mirrors 13 and the upper electrode 2 or lower electrode 3. The protective quartz plates 14 have the capability to prevent contamination of the surfaces of the reflection mirrors 13 by an entity emitted from the upper electrode 2 and lower electrode 3 that have extremely high temperature (a sublimate of graphite or a product of an added gas), or to prevent invasion of a contaminate, which has a possibility of being mixed in the sample to be heated, 1 from any of the reflection mirrors 13. Incidentally, even when the reflection mirrors 13 are not included, a heat treatment apparatus that can exhibit a low heat capacity and perform uniform heating can be provided.

The basic actions of the heat treatment apparatus using plasma and being shown in FIG. 1A have been described on the assumption that heating treatment is performed by filling the container 9, which is deaerated to become vacuum, with a He gas of a certain pressure (1 atm.) and sealing the container. When heating treatment is performed with the container filled with the He gas, the operation is simple. However, there is a fear that heating may invite a variation in a pressure or a decrease in the purity of a gaseous atmosphere. Therefore, while a certain amount of He gas is introduced by the gas introduction unit 10 during heat treatment, a magnitude of exhaustion is preferably controlled in order to sustain a predetermined pressure (1 atm. in the present embodiment). If a flow rate of He to be introduced is high, a heat loss is increased and heating efficiency is degraded. In contrast, if the flow rate is too low, the ability of sustaining the purity of the He atmosphere is degraded. Therefore, an amount of gas to be introduced during heat treatment should preferably range from 10 sccm to 10000 sccm.

In the basic construction of the heat treatment apparatus shown in FIG. 1A, the gap 4 is set to 0.8 mm. Even when the gap 4 ranges from 0.1 mm to 2 mm, the same advantage can be exerted. Even when the gap is narrower than 0.1 mm, discharge can be formed. However, unfavorably, a high-precision facility becomes necessary to maintain the parallelism between the upper electrode 2 and lower electrode 3, and alteration (roughness) of an electrode surface adversely affects plasma. In contrast, when the gap 4 exceeds 2 mm, degradation in the ignitability of plasma or an increase in a radiation loss occurring in the gap unfavorably poses a problem.

For the basic actions of the heat treatment apparatus shown in FIG. 1A, the pressure at which plasma is formed is 1 atm. The same actions can be performed even when the pressure ranges from 0.1 atm. to 10 atm. When the heat treatment apparatus is allowed to act under a pressure lower than 0.1 atm., a heat loss caused by heat transfer from the upper electrode 2 and lower electrode 3 through a gaseous atmosphere can be minimized. In addition, a transition from glow discharge to arc discharge deriving from a temperature rise can be suppressed. However, when the pressure is lower than 0.1 atm., ions in the plasma enter the sample to be heated 1 while gaining relatively high energy. This is unfavorable because the sample to be heated may be damaged. In general, kinetic energy that damages a crystalline surface is 10 electronvolt (eV) or more. When ions are accelerated to gain the kinetic energy exceeding 10 eV, they damage the sample to be heated. Therefore, it is necessary to restrict the energy of ions, which enter the sample to be heated 1, to 10 eV or less. Ions contained in plasma are accelerated with a voltage developed in an ion sheath formed on the surface of the sample to be heated 1, and then enter the sample to be heated. The voltage in the ion sheath is developed with an energy difference between ions and electrons in a plasma bulk. Therefore, under atmospheric pressure under which ions, electrons, and neutral particles are in a thermal equilibrium state, development of a voltage in the ion sheath is rare. In addition, since collision with neutral atoms on the ion sheath occurs about 100 to 1000 times, damaging the surface of the sample to be heated 1 with incidence of ions hardly take place. However, while the pressure is being decreased, there arises a difference in kinetic energy between ions and electrons. A voltage that accelerates the ions is developed in the ion sheath.

Assume that a potential difference ranging from, for example, several tens of volts to about 100 V occurs in the ion sheath. The thickness of the ion sheath usually ranges from several tens of micrometers to several hundreds of micrometers. In contrast, the mean free path of He ions is 20 μm or less in an He atmosphere of 0.1 atm. or less and 1800° C. This raises the possibility that: the number of times of collision in the ion sheath may range about 1 to 10; a percentage by which ions are accelerated with a voltage close to a voltage equivalent to the potential difference may get larger; and ions having energy which exceeds 10 eV may enter the sample to be heated.

For the basic actions of the heat treatment apparatus shown in FIG. 1A, He is adopted as a raw gas to be used to produce plasma. Needless to say, even when a rare gas such as Ar, Xe, or Kr is adopted, the same advantages can be exerted. Although He used to describe the actions is superior in ignitability of plasma at a pressure near atmospheric pressure and safety, the thermal conductivity of the gas is so high that a heat loss caused by heat transfer through a gaseous atmosphere is relatively large. In contrast, a gas of a large mass such as Ar is poor in the thermal conductivity. This is advantageous in terms of heat efficiency. When a gas of a hydrocarbon series is added to the rare gas in order to produce plasma, a carbon protective film that prevents surface roughness deriving from heating can be formed on the surface of the sample to be heated 1 in a stage preceding heating. Likewise, when gaseous oxygen is added after completion of heating (in a stage in which the temperature of the sample to be heated 1 is decreased to some extent) in order to produce plasma, the carbon-series coating can be removed.

In the aforesaid embodiment, graphite coated with silicon carbide according to a chemical vapor deposition (CVD) method is used to form the upper electrode 2 and lower electrode 3. Alternatively, even when graphite alone, a member produced by coating graphite with thermolytic carbon, a member produced by vitrifying a graphite surface, a compound of carbon and a high-melting point metal (tantalum (Ta), tungsten (W), or the like), or SiC (sintered compact, single crystal, or polycrystalline material) is adopted, the same advantages can be exerted. Needless to say, that is a base material of the upper electrode 2 and lower electrode 3, and a coating to be applied to the graphite surface are both requested to exhibit high purity in terms of contamination prevention. At extremely high temperature, contamination may affect the sample to be heated 1 over the feeder lines 5 and 7. Therefore, in the present embodiment, the feeder lines 5 and 7 are, similarly to the upper electrode 2 and lower electrode 3, made of graphite. Heat dissipated from the upper electrode 2 and lower electrode 3 is transferred over the feeder lines 5 and 7 and then lost. Therefore, it is necessary to limit heat transfer over the feeder lines 5 and 7 to a minimal necessary level. Therefore, the sectional area of the feeder lines 5 and 7 made of graphite has to be as small as possible, and the length thereof has to be as long as possible. However, if the sectional area of the feeder lines 5 and 7 is made extremely small and the length thereof is made too long, a high-frequency power loss on the feeder lines 5 and 7 increases. This invites degradation in heating efficiency for the sample to be heated 1. In the present embodiment, from the foregoing viewpoints, the sectional area of the feeder lines 5 and 7 made of graphite is set to 12 mm², and the length thereof is set to 40 mm. The same advantages can be exerted as long as the sectional area ranges from 5 mm² to 30 mm² and the length ranges from 30 mm to 100 mm.

In the present embodiment, heat dissipation from the upper electrode 2 and lower electrode 3 which determines heating efficiency is, as mentioned above, dominated mainly by (1) radiation, (2) heat transfer through a gaseous atmosphere, and (3) heat transfer over the feeder lines 5 and 7. Among the dominators, the primary one is (1) radiation. The reflection mirrors 13 are used to suppress the radiation. Heat dissipation over the feeder lines 5 and 7 is minimized by, as mentioned above, optimizing the sectional area of the feeder lines and the length thereof. (2) Heat transfer through the gaseous atmosphere is suppressed by controlling an electrothermal distance of a gas (a distance from each of the upper electrode 2 and lower electrode 3, which are regarded as a high-temperature portion, to one of the reflection mirrors 13 or the wall of the container 9 which is regarded as a low-temperature portion). The percentage of heat dissipation due to heat transfer through a gas gets relatively high in a He atmosphere under atmospheric pressure (because the thermal conductivity of He is high). Therefore, the present embodiment adopts a structure in which 30 mm or more is preserved as the distance from each of the upper electrode 2 and lower electrode 3 to one of the reflection mirrors 13 or the wall of the container 9. The longer distance is more advantageous for suppression of heat dissipation. However, unfavorably, the size of the container 9 becomes too large for a region to be heated. Once the distance of 30 mm or more is preserved, while the size of the container 9 is suppressed, heat dissipation due to heat transfer through a gaseous atmosphere can be suppressed. Needless to say, when Ar or the like exhibiting low thermal conductivity is adopted or a gas pressure is decreased (0.1 atm. or more), heat transfer through the gaseous atmosphere can be further suppressed.

In the first embodiment, 13.56 MHz is employed in bringing about electric discharge. This is because since 13.56 MHz is a frequency for industrial use, a power source is available at a low cost. In addition, a criterion for leakage of an electromagnetic wave is so low that the cost of the apparatus can be lowered. However, needless to say, heating can be achieved at any other frequency under the same principles. In particular, a frequency that is equal to or larger than 1 MHz and falls below 100 MHz is preferred for the present invention. At a frequency lower than 1 MHz, a high-frequency voltage needed to feed power necessary to heating gets higher. This is unfavorable because abnormal discharge (unstable discharge or discharge occurring other than the space between the upper electrode and lower electrode) occurs and it becomes hard to perform stable actions. A frequency exceeding 100 MHz is not preferred because the impedance in the gap between the upper electrode 2 and lower electrode 3 is low and it becomes hard to develop a voltage necessary to produce plasma.

In relation to the first embodiment, a description has been made of a construction in which the one sample to be heated 1 is placed on the lower electrode 3 disposed inward the sole reflection mirror 13. Alternatively, the reflection mirrors 13, upper electrode 2, and lower electrode 3 may be made large in size, and the plural samples to be heated 1 may be disposed on the lower electrode 3. Thus, the number of samples to be heated capable of being treated at a time may be increased. In this case, a high-frequency power suitable for the size of the upper electrode 2 and lower electrode 3 (nearly proportional to the area of the upper electrode 2 and lower electrode 3) has to be fed.

Likewise, in relation to the first embodiment, a description has been made of such a construction that a pair of the reflection mirrors 13 and a pair of the upper electrode 2 and lower electrode 3 (including the sample to be heated 1) are disposed in the container 9. Needless to say, a large container may be used, and plural pairs of the reflection mirrors 13, and plural pairs of the upper electrode 2 and lower electrode 3 may be disposed. Thus, needless to say, the number of samples to be heated capable of being treated at a time may be increased.

In the first embodiment, a member on which gold is plated or vapor-deposited is adopted as the surfaces of the reflection mirrors 13. Needless to say, even when aluminum, an aluminum alloy, silver, a silver alloy, or a stainless steel is adopted as the material of the mirror surfaces, the same advantages can be exerted. In addition, although the reflection mirrors 13 are formed with paraboloids of revolution, even when planar reflection mirrors are disposed on the perimeters of the upper electrode 2 and lower electrode 3, the same advantages are exerted.

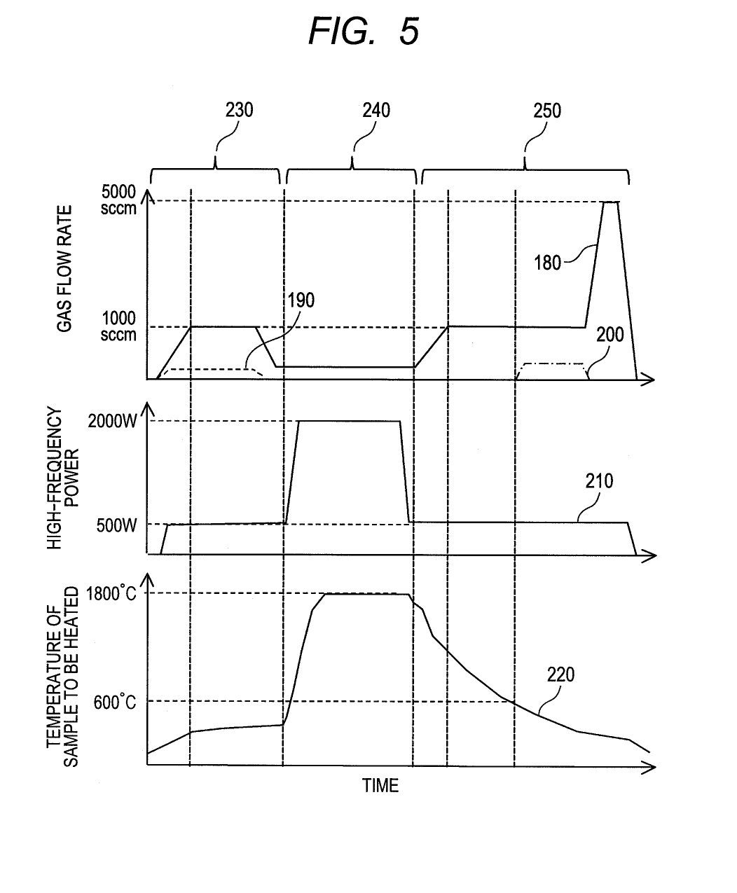

FIG. 5 shows an example of a sequence of basic actions to be performed in the heat treatment apparatus shown in FIG. 1A. FIG. 5 is concerned with a case where formation and removal of a surface protective film that prevents the surface roughness of a sample to be heated are performed concurrently with a series of heating treatment steps. To begin with, a rare gas (He) 180 that is a base material and a fluorocarbon gas 190 to be used to form the surface protective film are introduced. Electrical discharge is formed with a relatively low power (500 W), and a protective film is formed on the surface of the sample to be heated (treatment time 230). Thereafter, feed of the protective film formation gas 190 is ceased, and a flow rate of the rare gas (He) 180 is lowered. The discharge power 210 is raised up to a power necessary to heating (2000 W). Accordingly, the temperature 220 of the sample to be heated rises to 1800° C. (treatment time 240). After heating treatment is completed, the flow rate of the rare gas (He) 180 is raised for the purpose of cooling, and the discharge power 210 is decreased. When the temperature decreases to some extent (600° C.), oxygen gas 200 for use in removing the protective film is added to the rare gas 180 in order to remove the protective film (treatment time 250). The example of the series of treatment steps has been described so far. In the sequence shown in FIG. 5, steps of forming and removing the protective film are added. As for suppression of surface roughness, it can be achieved by cutting an extra heating time through shortening of heating and cooling times that is a feature of the present embodiment, or by forming in advance the protective film on the surface of the sample to be heated. In this case, treatment is carried out according to a sequence having formation of the protective film shown in FIG. 5 excluded therefrom.

As mentioned above, according to the present embodiment, owing to inclusion of a temperature measurement instrument that measures the temperature of a sample to be heated (lower electrode) which is heated with plasma generated through glow discharge formed in a pair of parallel plate electrodes, and a control unit that controls the output of a high-frequency power supply using the temperature measured by the temperature measurement instrument,

a heat treatment apparatus that can exhibit a low heat capacity and perform uniform heating can be provided. In addition, when reflection mirrors that minimize a radiation loss are further included, even when SiC is annealed at high temperature, there is provided the heat treatment apparatus that can exhibit a low heat capacity and perform uniform heating.

### Second Embodiment

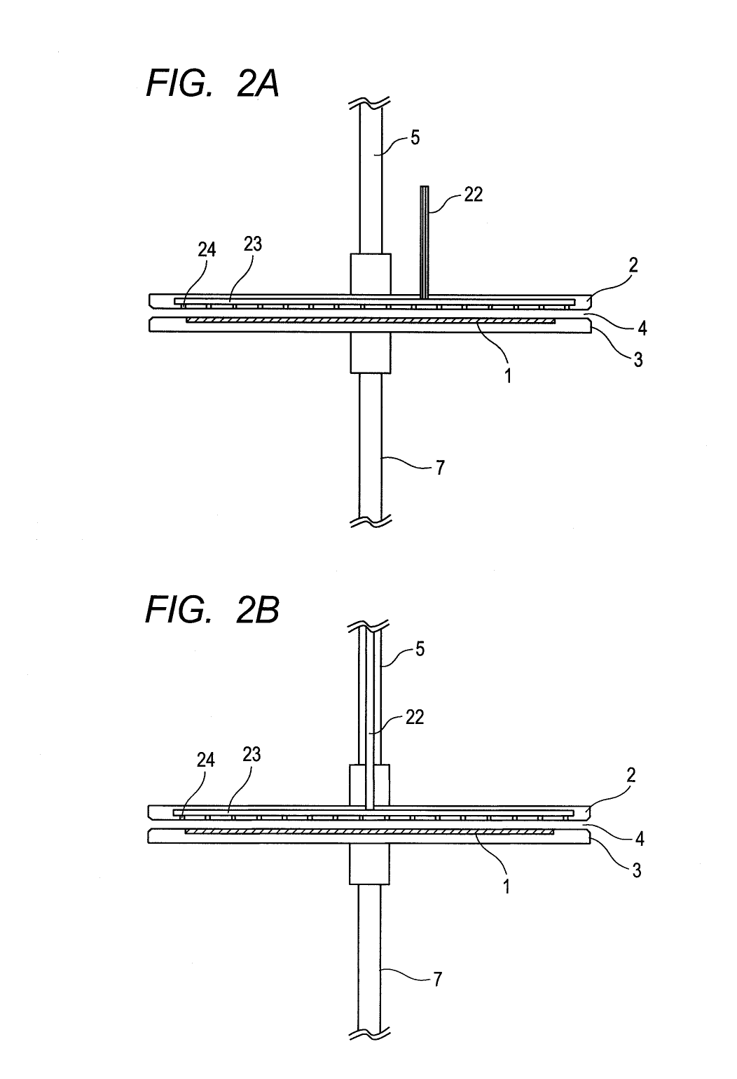

A second embodiment will be described in conjunction with FIG. 2A and FIG. 2B. Items that have been described in relation to the first embodiment but will not be described in relation to the present embodiment will apply to the present embodiment unless the circumstances are exceptional.

FIG. 2A is a sectional view of an electrical discharge formation unit included in a heat treatment apparatus in accordance with the present embodiment employing plasma. In relation to the second embodiment, only a difference from the first embodiment will be described below. FIG. 2A and FIG. 2B are enlarged view of a portion equivalent to the upper electrode 2 and lower electrode 3 included in the first embodiment. In the second embodiment shown in FIG. 2A and FIG. 2B, unlike the embodiment shown in FIG. 1A to FIG. 10, the upper electrode 2 is provided with a second gas introduction unit 22, a gas diffuse layer 23, and gas jet holes 24. The other components are identical to those of the first embodiment shown in FIG. 1A to FIG. 1C. A difference in a construction between FIG. 2A and FIG. 2B lies in a point that in FIG. 2B, the second gas introduction unit 22 is incorporated in the feeder line 5. When the upper electrode 2 is used as part of the gas introduction unit, a gas composition in the gap 4 in which plasma is produced is altered from a gas composition in the container 9. For example, a He gas that is superior in ignitability for electrical discharge and in stableness is introduced from the second gas introduction unit 22, while Ar exhibiting low thermal conductivity is introduced into the container 9. Thus, both improvement of heating efficiency through suppression of heat dissipation and stabilization of plasma production can be accomplished. In addition, when a protective film for use in preventing surface roughness is formed on the surface of the sample to be heated 1, if the raw gas (hydrocarbon-series gas) is mixed in a rare gas and introduced by the second gas introduction unit 22, the protective film can be uniformly formed with a small amount of raw gas. When the second gas introduction unit 22 is, as shown in FIG. 2B, incorporated in the feeder line 5, radiation in the vicinity of the upper electrode 2 is made uniform.

Even the present embodiment provides the same advantages as the first embodiment does. Further, when the second gas introduction unit 22 is included, both improvement of heating efficiency and stabilization of plasma production can be accomplished.

### Third Embodiment

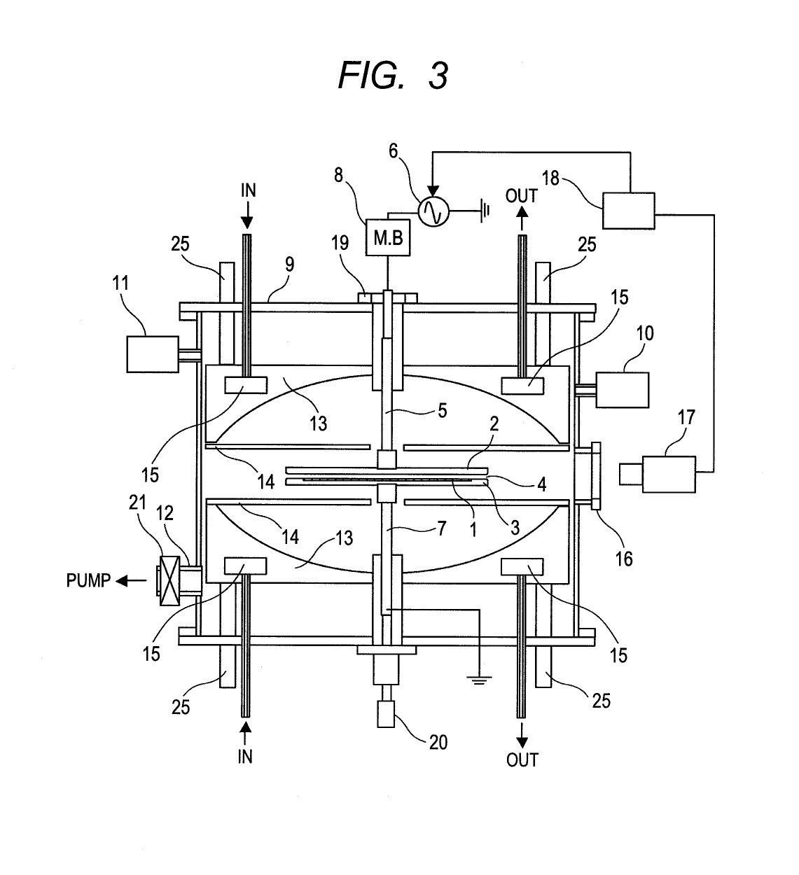

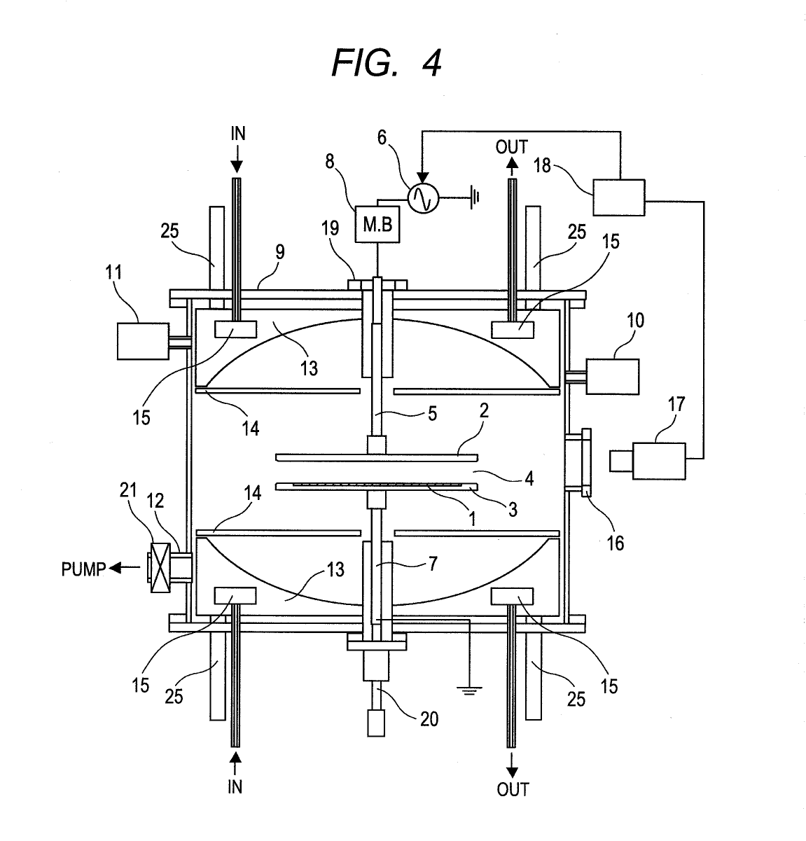

A third embodiment will be described in conjunction with FIG. 3 and FIG. 4. Items that have been described in relation to the first or second embodiment but will not be described in relation to the present embodiment can apply to the present invention unless the circumstances are exceptional.

FIG. 3 and FIG. 4 are diagrams showing a basic construction of a heat treatment apparatus in accordance with the third embodiment of the present invention employing plasma. FIG. 3 shows a state in which heating treatment is under way, and FIG. 4 shows a state in which the treatment is completed. In relation to the third embodiment, only a difference from the first embodiment will be described below. In FIG. 3 and FIG. 4, an up-and-down driving mechanism 25 for the reflection mirrors 13 is added to the construction of the first embodiment shown in FIG. 1A to FIG. 1C. As shown in FIG. 3, during heating treatment, the upper electrode 2 and lower electrode 3 are located as close to the reflection mirrors 13 as possible (a distance of 30 mm or more making it possible to suppress an adverse effect of heat transfer through a gaseous atmosphere described in relation to the first embodiment). This is intended to suppress a loss caused by radiation. In contrast, after heating is completed, the temperature has to be lowered as quickly as possible. The suppression of a radiation loss by the reflection mirrors 13 hinders cooling. Therefore, after heating treatment is completed, the up-and-down mechanism 25 is, as shown in FIG. 4, used to separate the reflection mirrors 13 from the upper electrode 2 and lower electrode 3. Thus, the effect of the reflection mirrors 13 is minimized in order to raise a temperature-drop speed. Preferably, the distance between the upper reflection mirror and upper electrode 2, and the distance between the lower reflection mirror and lower electrode 3 are adjusted so that they become identical to each other (especially, during heating treatment).

The advantages of the present invention described in relation to the first, second and third embodiments will be summarized below. According to the present technology, heating of a gas due to glow discharge formed at atmospheric pressure in the narrow gap is used as a heat source to heat the sample to be heated 1. Based on the principles, four advantages unavailable in related arts and described below are provided.

A first advantage lies in heating efficiency. Since the gas in the gap between the upper electrode and lower electrode as well as the upper electrode and lower electrode (sample stand) should merely be heated, the heat capacity can be drastically lowered. In addition, the upper electrode 2 and lower electrode 3 including the sample to be heated 1 are covered by the reflection mirrors formed with paraboloids of revolution. Therefore, since the sample to be heated 1 can be heated in a system in which a heating loss caused by radiation is very small, high energy efficiency can be realized and high-temperature heating can be achieved.

A second advantage lies in heating responsiveness and uniformity. Owing to the aforesaid construction, the heat capacity of a heating unit is so small that a rapid temperature rise and a rapid temperature drop can be achieved. Since heating of a gas due to glow discharge is used as a heat source, heating can be achieved uniformly on a planar basis owing to a spread of the glow discharge. The temperature uniformity is so high that a variance in device characteristics on the surface of the sample to be heated 1, which derives from heat treatment, can be suppressed. At the same time, a damage caused by a thermal stress deriving from a temperature difference on the surface of the sample to be headed 1 occurring when a rapid temperature rise is attained can be suppressed.

A third advantage lies in minimization of the number of parts wasted during heating treatment. In the present technology, since a gas that comes into contact with the sample to be heated 1 is directly heated, a region in which the temperature rises is limited to a member disposed very close to the sample to be heated 1, and the temperature in the region is equal to or lower than the temperature of the sample to be heated 1. Therefore, the service life of the member is long, and a region in which a part has to be replaced with a new one because of deterioration is limited.

A fourth advantage lies in suppression of surface roughness of the sample to be heated 1. According to the present technology, since the temperature rise time and temperature drop time can be shortened according to the foregoing advantages, even if the sample surface is bared, the time it takes to expose the sample to be heated 1 to a high-temperature environment is shortened to be a minimal necessary time. Accordingly, the surface roughness can be suppressed. In addition, according to the present technology, the sample to be heated is exposed to plasma due to atmospheric-pressure glow discharge and is thus heated. In the stage of heating, plasma produced from a rare gas is employed. A reactive gas is added to the rare gas in the course of a temperature rise or drop, whereby formation of a protective film and removal thereof can be consistently performed during heating. Therefore, the steps of forming and removing the protective film which are performed in an apparatus other than the heat treatment apparatus become unnecessary. This leads to a reduction in a cost of fabrication.

In the first to third embodiments, the reflection mirrors 13 are used to improve the efficiency in heating the upper electrode 2, lower electrode 3, and sample to be heated 1. For example, when treatment is performed at relatively low temperature of, for example, 1200° C. or less, the reflection mirrors 13 are not always necessary. The reflection mirrors are intended to minimize a heat loss caused by radiant emission. At 1200° C. or less at which a radiation loss is not very large, a structure devoid of the reflection mirrors 13 can fulfill the required role. In this case, the basic construction includes the upper electrode 2 and lower electrode 3 which include the sample to be heated 1, the high-frequency power supply 6 that feeds a high-frequency power to the electrodes, an instrument that monitors the temperature of any of the sample to be heated 1 and the upper and lower electrodes (radiation thermometer 17), a unit that controls the power of the high-frequency power supply 6 by referencing the monitored value of the temperature, and a mechanism that controls a region to be discharged in an atmosphere of a rare gas whose pressure ranges from 0.1 atm. to 10 atm. or a gas to be added to the rare gas in order to form a protective film or remove the protective film.

As mentioned above, even the present embodiment can provide the same advantages as the first embodiment can. When the up-and-down driving mechanism that moves the reflection mirrors up and down is further included, a temperature rise/drop speed can be raised.

The present invention has been described so far. The major modes of the present invention will be listed below.

(1) A heat treatment apparatus including:
a pair of parallel plate electrodes;
a high-frequency power supply that applies a high-frequency voltage to the pair of parallel plate electrodes so as to discharge between the pair of parallel plate electrodes;
a temperature measurement instrument that measures the temperature of a sample to be heated which is disposed in the pair of parallel plate electrodes;
a gas introduction unit that introduces a gas to the pair of parallel plate electrodes; and
a control unit that controls the output of the high-frequency power supply.

Herein, the control unit references the temperature measured by the temperature measurement instrument, and controls the output of the high-frequency power supply so as to control the heat-treatment temperature for the sample to be heated.

(2) A heat treatment apparatus including:
a pair of parallel plate electrodes;
a high-frequency power supply that applies a high-frequency voltage to the pair of parallel plate electrodes so as to discharge between the pair of parallel plate electrodes;
a temperature measurement instrument that measures the temperature of a sample to be heated which is disposed in the pair of parallel plate electrodes;
a gas introduction unit that introduces a gas to the pair of parallel plate electrodes;
reflection mirrors that surround the pair of parallel plate electrodes; and
a control unit that controls the output of the high-frequency power supply.

Herein, the control unit references the temperature measured by the temperature measurement instrument, and controls the output of the high-frequency power supply so as to control the heat-treatment temperature for the sample to be heated.

(3) In the heat treatment apparatus as set forth in paragraph (2), the gas introduction unit includes a first gas introduction unit and a second gas introduction unit. The first gas introduction unit has a gas introduction port thereof located outside a gap created in the pair of parallel plate electrodes, while the second gas introduction unit has a gas introduction port thereof located within the gap in the pair of parallel plate electrodes. The first and second gas introduction units introduce a gas independently of each other.
(4) In the heat treatment apparatus as set forth in paragraph (2), as the pair of parallel plate electrodes, plural pairs of electrodes are included.
(5) In the heat treatment apparatus as set forth in paragraph (2), the control unit controls the gas introduction unit so that before heat treatment is performed on the sample to be heated or while the temperature is rising, a carbon-containing molecular gas can be added to plasma stemming from discharge in order to form a protective film, which is a carbon-series coating, on the surface of the sample to be heated.
(6) In the heat treatment apparatus as set forth in paragraph (5), after heat treatment is performed, the control unit extends control so that oxygen can be added to the plasma, which stems from discharge, in order to remove the protective film.
(7) A heat treatment apparatus including:
a high-frequency power supply;
a lower electrode on which a sample to be heated is placed;
an upper electrode to which the high-frequency power supply is connected and which is located at a position opposite to the position of the lower electrode;
a gas introduction unit that introduces a gas, from which plasma is produced, to the gap between the upper electrode and lower electrode; and
upper and lower reflection mirrors that cover the upper and lower electrodes via a space.
   (8) In the heat treatment apparatus as set forth in paragraph (7), the upper and lower reflection mirrors are each formed by optically polishing the surface of a metallic substrate shaped like a paraboloid of revolution, and the optically polished surface is made of any of gold, aluminum, an aluminum alloy, silver, a silver alloy, and stainless steel.
   (9) In the heat treatment apparatus as set forth in paragraph (7), a quartz plate is interposed between the upper electrode and upper reflection mirror, and between the lower electrode and lower reflection mirror.
   (10) The heat treatment apparatus as set forth in paragraph (7) further includes:
a thermometer that measures the temperature of the sample to be heated; and
a control unit that references the temperature measured with the thermometer, and controls the output of the high-frequency power supply.
   (11) The heat treatment apparatus as set forth in paragraph (7) further includes a control unit that controls a type of gas to be introduced by the gas introduction unit, a gas flow rate, and the output of the high-frequency power supply.

Herein, the control unit controls the gas introduction unit so that a protective film can be formed on the surface of the sample to be heated, controls the output of the high-frequency power supply so that the sample to be heated can be heated with the surface thereof coated with the protective film, and controls the gas introduction unit so that the protective film can be removed.

(12) In the heat treatment apparatus as set forth in paragraph (2), the reflection members are disposed above and below the pair of parallel plate electrodes, and the heat treatment apparatus further includes a driving mechanism that drives the reflection mirrors in up-and-down directions.
(13) The heat treatment apparatus as set forth in paragraph (7) further includes a driving mechanism that drives the upper and lower reflection mirrors in up-and-down directions.

What is claimed is:

1. A heat treatment apparatus comprising:
a pair of parallel plate electrodes:
a high-frequency power supply that applies a high-frequency voltage to the pair of parallel plate electrodes so as to discharge between the pair of parallel plate electrodes;
a temperature measurement instrument that measures the temperature of a sample to be heated which is disposed in the pair of parallel plate electrodes;
a gas introduction unit that introduces a gas into the pair of parallel plate electrodes; and
a control unit that controls the output of the high-frequency power supply, wherein
the control unit references the temperature measured by the temperature measurement instrument, and controls the output of the high-frequency power supply so as to control the heat-treatment temperature for the sample to be heated.

2. A heat treatment apparatus comprising:
a pair of parallel plate electrodes;
a high-frequency power supply that applies a high-frequency voltage to the pair of parallel plate electrodes so as to discharge between the pair of parallel plate electrodes;
a temperature measurement instrument that measures the temperature of a sample to be heated which is disposed in the pair of parallel plate electrodes;
a gas introduction unit that introduces a gas into the pair of parallel plate electrodes;
reflection mirrors that surround the pair of parallel plate electrodes; and
a control unit that controls the output of the high-frequency power supply, wherein
the control unit references the temperature measured by the temperature measurement instrument, and controls the output of the high-frequency power supply so as to control the heat-treatment temperature for the sample to be heated.

3. The heat treatment apparatus according to claim 2, wherein:
the gas introduction unit includes a first gas introduction unit and a second gas introduction unit;
the first gas introduction unit has a gas introduction port thereof located outside a gap created in the pair of parallel plate electrodes, while the second gas introduction unit has a gas introduction port thereof located within the gas in the pair of parallel plate electrodes; and
the first gas introduction unit and second gas introduction unit introduce a gas independently of each other.

4. The heat treatment apparatus according to claim 2, wherein as the pair of parallel plate electrodes, a plurality of pairs of electrodes is included.

5. The heat treatment apparatus according to claim 2, wherein the control unit controls the gas introduction unit so that before heat treatment is performed on the sample to be heated or while the temperature is rising, a carbon-containing molecular gas can be added to plasma, which stems from discharge, in order to form a protective film, which is a carbon-series coating, on the surface of the sample to be heated.

6. The heat treatment apparatus according to claim 5, wherein after heat treatment is completed, the control unit extends control so that oxygen can be added to plasma, which stems from discharge, in order to remove the protective film.

7. A heat treatment apparatus comprising:
a high-frequency power supply;
a lower electrode on which a sample to be heated is placed;
an upper electrode to which the high-frequency power supply is connected and which is located at a position opposite to the position of the lower electrode;
a gas introduction unit that introduces a gas, from which plasma is produced, into the gap between the upper electrode and lower electrode; and
upper and lower reflection mirrors that cover the upper and lower electrodes via a space.

8. The heat treatment apparatus according to claim 7, wherein the upper and lower reflection mirrors are each formed by optically polishing the surface of a metallic substrate shaped like a paraboloid of revolution, and the optically polished surface is made of any of gold, aluminum, an aluminum alloy, silver, a silver alloy, and stainless steel.

9. The heat treatment apparatus according to claim 7, wherein a quartz plate is interposed between the upper electrode and upper reflection mirror, and between the lower electrode and lower reflection mirror.

10. The heat treatment apparatus according to claim 7, further comprising a thermometer that measures the temperature of the sample to be heated, and a control unit that references the temperature measured by the thermometer and controls the output of the high-frequency power supply.

11. The heat treatment apparatus according to claim further comprising a control unit that controls a type of gas to be introduced by the gas introduction unit, a gas flow rate, and the output of the high-frequency power supply, wherein:
the control unit controls the gas introduction unit so that a protective film can be formed on the surface of the sample to be heated, controls the output of the high-frequency power supply so that the sample to be heated can be heated with the surface thereof coated with the protective film, and controls the gas introduction unit so that the protective film can be removed.

12. The heat treatment apparatus according to claim 2, wherein the reflection mirrors are disposed above and below the pair of parallel plate electrodes, and the heat treatment apparatus further includes a driving mechanism that drives the reflection mirrors in up-and-down directions.

13. The heat treatment apparatus according to claim 7, further comprising a driving mechanism that drives the upper and lower reflection mirrors in up-and-down directions.
